(19) United States
(12) Patent Application Publication
(10) Pub. No.: US 2023/0332076 A1
(43) Pub. Date: Oct. 19, 2023

(54) PACKAGING FOR PERFUME PARTICLES

(71) Applicant: Conopco, Inc., d/b/a UNILEVER, Englewood Cliffs, NJ (US)

(72) Inventors: Jane Margaret CARSON, Chester (GB); Katherine Ann GREENLEES, Wirral (GB); Adelle Louise KILLEY, Wirral (GB); Christopher Paul WEIR, Kelsall, Tarporley (GB)

(73) Assignee: Conopco, Inc., d/b/a UNILEVER, Englewood Cliffs, NJ (US)

(21) Appl. No.: 18/028,811

(22) PCT Filed: Sep. 24, 2021
(86) PCT No.: PCT/EP2021/076340

§ 371 Date: Mar. 28, 2023

(30) Foreign Application Priority Data
Sep. 30, 2020 (EP) 20199145.2
Sep. 30, 2020 (EP) 20199156.9

(51) Int. Cl. C11D 3/50; C11D 17/00; C11D 11/00

(52) U.S. Cl. CPC C11D 3/505; C11D 17/0039; C11D 11/0017

(57) ABSTRACT

A packaged laundry product comprising packaging and perfume particles contained in said packaging, wherein the packaging comprises: a) receptacle formed from a material comprising cellulosic fibres; and b) 1 to 5 wt. % of the packaging a perfume barrier layer; wherein the perfume particles comprise: i) carrier material; and ii) perfume components.

### FIELD OF THE INVENTION

The present invention is in the field of packaging for perfume particle laundry additives.

### BACKGROUND OF THE INVENTION

Perfume particle laundry additive products are known. These are solid particles which the consumer can add to the laundry process to enhance the fragrance delivered to the fabric.

EP 2496679 discloses scent additives. The compositions disclosed therein comprise polyethylene glycol, free perfume and perfume microcapsules and optionally a dye.

Consumers desire ‘plastic free’ products, however this desire must be balanced with efficacy of the packing. Due to the high levels of perfume in perfume particle compositions, there is a need to develop suitable packaging for such compositions.

Solid perfume additives such as those described in EP 2496679 will ‘rattle’ around inside the packaging in which they are stored. The collisions between particles result in the inevitable release of perfume from the particles, particularly in compositions which comprise perfume microcapsules. It is important that the product's packaging can contain the released perfume, so that when the consumer opens the packaging, they receive a ‘hit’ of perfume, thereby indicating the efficacy of the product.

The packaged composition described herein addresses the need for suitable packaging for perfume particles.

### SUMMARY OF THE INVENTION

In a first aspect of the present invention is provided a packaged laundry product comprising packaging and perfume particles contained in said packaging,
wherein the packaging comprises:
   a. a receptacle formed from a material comprising cellulosic fibres; and
   b. 1 to 5 wt. % of the packaging a perfume barrier layer;
wherein the perfume particles comprise:
   i. carrier material; and
   ii. 0.5 to 20 wt. % perfume components.

In a second aspect of the present invention is a method of storing perfume particles, wherein perfume particles comprising a carrier and perfume components are contained in packaging comprising a receptacle formed from a material comprising cellulosic fibres and 1 to 5 wt. % of the packaging a perfume barrier layer.

In a third aspect of the present invention is a use of packaging comprising a receptacle formed from a material comprising cellulosic fibres and 1 to 5 wt. % of the packaging a perfume barrier layer to contain perfume particles comprising a carrier and perfume components.

### DETAILED DESCRIPTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

The packaged laundry product described herein comprises packaging and perfume particles stored within said packaging. The packaging comprises a receptacle formed from a material comprising cellulosic fibres and a perfume barrier. The perfume particles comprise a carrier material and perfume components.

### Packaging

The packaging for the perfume particles described herein comprises a receptacle. The receptable preferably comprises a container and a lid. The lid may be separable from the container, i.e. a separate entity which may be entirely removed from the container to access the contents of the container, or it may be attached to the container for example by means of a hinge.

The receptable is formed from a material comprising cellulosic fibres. Preferably the receptacle is formed from cardboard (such as paperboard or corrugated fibreboard), paper pulp or other cellulosic fibre materials. More preferably the receptacle is formed from cardboard or paper pulp, most preferably cardboard. The cardboard may for example be a laminate structure, a composite structure, or a corrugated structure. Preferably the receptacle is formed from recycled materials i.e. from cellulosic fibres previously used in industry or by consumers. Paper pulp may be preferable when the receptacle comprises aspects which need to be moulded. It may be that case that the container and the lid of the receptable are made from different materials, for example the container being made from cardboard and the lid from paper pulp.

Preferably the density of the material comprising cellulosic fibres is 100 g/m².

When using cardboard, the cardboard may comprise multiple sheets of material. In this case there may be disposed a sheet of corrugated cardboard between the sheets. The receptible may be manufactured in the form of a sheet or blank, which is folded to make a container and lid. In this case preferably the sheet or blank is shaped to form the whole container from one sheet or blank. Most preferably the sheet or blank is weakened (such as by scoring) to aid the folding process. The sheet of blank may include flaps or tabs for aiding the joining of sides of the external skin, and which may not be visible when the external skin has been assembled into its final shape. The flaps or tabs may be fixed in place using an adhesive material.

The receptacle may be any suitable shape for storing the perfume particles described herein. Preferred shapes include a cuboid (e.g. a cube wherein length=width=height or rectangular cuboid wherein one of the measurements length, height and width is different from the other two measurements or rectangular cuboid wherein all three measurements are different) or a cylinder (with a circular or elliptical cross section). If the receptacle is a cuboid, the corners and/or edges may be rounded.

The receptacle may further comprise a child impeding closure (CIC). A CIC may be formed using ribs and ridges, requiring specific manipulation of the container or lid to separate the two parts. Alternatively, a CIC may be formed by friction fit of the container and the lid, i.e. the friction between the two parts is sufficient to impede a child's access to the contents of the receptacle. Alternatively a CIC may be formed by an arrangement of tabs on the container interacting with holes in the lid, whereby the user must insert their finger into a hole in the lid to release a tab on the container and allow the lid to be released. Alternatively, a CIC may be formed wherein the lid constitutes a rotatable section, which when rotated aligns with a hole in the container and creates a hole through which the contents of the container can be poured. Alternatively, a CIC may be formed by an additional fastening means, such as a clip or pin locking the container and lid together, etc. The person skilled in the art may use these or any other mechanism to impede the ability of a child to access the contents of the container.

The receptacle may be printed on using conventional inks. The printing may occur before or after the formation of the container and lid.

The packaging for the packaged laundry product described herein comprises a perfume barrier. The perfume barrier constitutes 1 to 5 wt. % of the packaging, preferably 1.5 to 4 wt. % of the packaging. When the perfume barrier is present in a level of 1 to 5 wt. % of the total packaging, this provides a significant reduction in perfume leakage so that the consumer receives a ‘hit’ of perfume when opening the receptacle, while maintaining the recyclability of the receptacle.

Preferably the perfume barrier is either coated on the material comprising cellulosic fibres or incorporated into the material comprising cellulosic fibres. The perfume barrier may generally fall into the category of a foil, film or wax which coats or is incorporated into the material comprising cellulosic fibres. Preferably the perfume barrier layer is coated on the entire internal and/or external surface of the receptacle or alternatively incorporated into all parts of the material comprising cellulosic fibres used to manufacture the receptacle, i.e. the lid and container. Most preferably the perfume barrier layer is coated on the entire internal and/or external surface of the receptacle.

The perfume barrier material may preferably be selected from the group consisting of a polyglycolic acid (PGA), pofyolefin (e.g., polyethylene, polypropylene), polyvinylidene chloride, polyvinyl alcohol, polyvinyl acetate, nanoclay (e.g. montmorillonites, vermiculite platelets), graphene, graphene oxide, calcium carbonate, wax, varnish, aluminium foil, metal, metal oxides and mixtures thereof. More preferably the perfume barrier material is selected from polyolefins, polyvinyl alcohols, poly acetates, waxes and mixtures thereof.

As used herein, the term “polyolefin” refers to a virgin, petroleum-based polyolefin, consumer recycled polyolefin, industrial recycled polyolefin, polyolefin derived from a renewable resource (i.e., produced by a natural process at a rate comparable to its rate of consumption, such as plants, animals, fish, bacterial, fungi, and forestry products), or a mixture thereof.

Specific examples of suitable preferred perfume barrier materials include: ethylene vinyl alcohol co-polymer (EVOHs), polyethylene (PE), polyethylene terephthalate (PET), polypropolyene, polypropylene (PP), polyester, polyamides; ethylene vinyl acetate; ethylene acrylic acid; polystyrene, polycarbonate, Polyhydroxyalkanoates (PHAs) and mixtures thereof. These polymers may be produced from virgin, recycled or renewable sources.

Preferably the perfume barrier comprises recycled material. More preferably the perfume barrier consists of recycled material.

It may be preferable to apply a primer to the surface of the paper board before applying the perfume barrier layer.

### Perfume Particles

The perfume particles described herein comprise a carrier material and perfume components. The particles may preferably comprise additional fabric benefit agents.

The carrier material, i.e. the material which constitutes the majority of the perfume particle is a solid. The perfume particles described herein comprise at least 50 wt. % carrier materials, preferably 65 wt. %, more preferably 80 wt. % and most preferably at least 90 wt. % carrier materials, by weight of the perfume particle. Preferably the perfume particles comprise less than 98 wt. % carrier material.

The carrier material may be any material which disperses, dissolves, disintegrates or solubilises in water. The perfume particle my comprise one carrier material or a combination of different carrier materials.

The carrier material may be selected from the group consisting of: synthetic polymers (e g, polyethylene glycol, ethylene oxide/propylene oxide block copolymers, polyvinyl alcohol, polyvinyl acetate, and derivatives thereof), proteins (e.g., gelatin, albumin, casein), saccharides (e.g. dextrose, fructose, galactose, glucose, isoglucose, sucrose), polysaccharides (e.g., starch, xanthan gum, cellulose, or derivatives thereof), water-soluble or water dispersible fillers (e.g. sodium chloride, sodium sulfate, sodium carbonate/bicarbonate, zeolite, silica, clay), vegetable soap (e.g. coconut soap beads or palm soap), ethoxylated non-ionic surfactants (having a formula R₁O(R₂O)xH, wherein R₁ preferably comprises 12 to 20 carbon atoms, R₂ is C₂H₄ or mixture of C₂H₄ and C₃H₆ units and x=8 to 120) and combinations thereof.

Examples of suitable carrier materials include: water soluble organic alkali metal salt, water soluble inorganic alkaline earth metal salt, water soluble organic alkaline earth metal salt, water soluble carbohydrate, water soluble silicate, water soluble urea, starch, xanthan gum, dextrose, clay, water insoluble silicate, citric acid carboxymethyl cellulose, fatty acid, fatty alcohol, glyceryl diester of hydrogenated tallow, glycerol, polyvinyl alcohol, non-ionic surfactants sold under the trade name Lutensol ex. BASF and combinations thereof.

Preferred carrier materials may be selected from the group consisting of synthetic polymers (e g, polyethylene glycol, ethylene oxide/propylene oxide block copolymers, polyvinyl alcohol, polyvinyl acetate, and derivatives thereof), polysaccharides (e.g., starch, xanthan gum, cellulose, or derivatives thereof), saccharides (e.g., dextrose, fructose, galactose, glucose, isoglucose, sucrose), vegetable soap (e.g. coconut soap beads or palm soap), ethoxylated non-ionic surfactants (having a formula R₁O(R₂O)xH, wherein R₁ preferably comprises 12 to 20 carbon atoms, R₂ is C₂H₄ or mixture of C₂H₄and C₃H₆ units and x=8 to 120) and combinations thereof.

More preferably the carrier is selected from polyethylene glycol, starch, dextrose, coconut soap beads, palm soap, non-ionic surfactants and combinations thereof.

Polyethylene glycol comes in various weight average molecular weights. A suitable weight average molecular weight of PEG for the purposes of the present invention includes from 4,000 to 12,000, preferably 5,000 to 11,000, more preferably 6,000 to 10,000 and most preferably 7,000 to 9,000. Non-limiting examples of suitable PEG is are: Polyglycol 8000 ex Clariant and Pluriol 8000 ex BASF.

Saccharides are molecular compounds comprising carbon, hydrogen and oxygen. For the purposes of this invention a saccharide is defined as comprising one to ten monosaccharide units and mixtures thereof. In other words either a monosaccharide or an oligosaccharide or mixtures thereof. An oligosaccharide is a short saccharide polymer, typically considered in the art to comprise between two and ten monosaccharides units. It is preferred that a saccharide comprises 1 to 5 monosaccharide units, more preferably 1 to 4 monosaccharide units, most preferably the saccharide comprises monosaccharides, disaccharides or mixtures thereof. Disaccharides are the product of a reaction between two monosaccharides. They may be formed from two identical monosaccharides or two different monosaccharides. Examples of disaccharides include: sucrose, maltose, lactose. Monosaccharides are simple sugar units having the general formula (CH₂O)ₙ. Commonly n is 3, 5 or 6. According, monosaccharides can be classified by the number n, for example: trioses (e.g. glyceraldehyde), pentoses (e.g. ribose) and hexoses (e.g. fructose, glucose and galactose). Some monosaccharides may be substituted with additional functional groups, e.g. Glucosamine, others may have undergone deoxgenation and lost an oxygen atom e.g. deoxyribose. Therefore, the general chemical formulae can vary slightly depending on the monosaccharide.

Preferred monosaccharides for the present invention are hexose molecules (n=6). Hexose molecules all have the same molecular formula, however, have a different structural formula, i.e. are structural isomers. It is preferred that the hexose comprises a 6-membered ring, opposed to a 5 membered ring. Glucose and galactose have 6-membered rings. In a preferred embodiment the hexose monosaccharide is glucose. Glucose is a chiral molecule, having a mixture of D and L stereo isomers. Particularly preferably, the glucose of the present invention is the D isomer of glucose, also known as dextrose.

Preferably a saccharide material used in the present invention is anhydrous, i.e. free of any water. For example, dextrose monohydrate contains one molecule of water whereas anhydrous dextrose contains none.

Non-limiting examples of suitable saccharides for the present invention are: C*Dex ex Cargill, Treha ex Cargill, Anhydrous Dextrose ex Foodchem.

When a saccharide is used in the present invention, it may be preferable to include bitter material such as Bitrex ex Johnson Matthey Fine Chemicals, due to the sweetness of the saccharide.

Preferred ethoxylated non-ionic surfactants have a general formula RO(C₂H₄O)xH, wherein R is a saturated alcohol having a carbon chain of C₁₂ to C₂₀ and wherein x is 8 to 120, preferably 25 to 90 and most preferably 45 to 85.

The perfume particles of the present invention comprise 0.5 to 20 wt. % perfume components. Perfume components may comprise free oil perfume, perfume microcapsules or combinations thereof.

Preferably the perfume particles of the present invention comprise 1 to 20 wt. % perfume components, more preferably 2 to 15 wt. % components, most preferably 4 to 10 wt. % perfume components. By perfume components it is meant the combined free perfume and any encapsulated perfume.

The perfume particles of the present invention may comprise one or more perfume compositions. The perfume compositions may be in the form of a mixture of free perfume compositions or a mixture of encapsulated and free oil perfume compositions.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

Particularly preferred perfume components are blooming perfume components and substantive perfume components. Blooming perfume components are defined by a boiling point less than 250° C. and a LogP greater than 2.5. Substantive perfume components are defined by a boiling point greater than 250° C. and a LogP greater than 2.5. Preferably a perfume composition will comprise a mixture of blooming and substantive perfume components. The perfume composition may comprise other perfume components.

It is commonplace for a plurality of perfume components to be present in a perfume composition. In the compositions for use in the present invention it is envisaged that there will be three or more, preferably four or more, more preferably five or more, most preferably six or more different perfume components. An upper limit of 300 perfume ingredients may be applied.

Free perfume may preferably be present in an amount from 0.01 to 20 wt. %, more preferably 0.1 to 15 wt. %, more preferably from 0.1 to 10 wt. %, even more preferably from 0.1 to 6.0 wt. %, most preferably from 0.5 to 6.0 wt. %, based on the total weight of the perfume particles.

Preferably some of the perfume components are contained in a microcapsule. Suitable encapsulating materials may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a LogP greater than 2.5. Substantive perfume components are defined by a boiling point greater than 250° C. and a LogP greater than 2.5. Preferably a perfume composition will comprise a mixture of blooming and substantive perfume components. The perfume composition may comprise other perfume components. It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume ingredients may be applied.

Encapsulated perfume may preferably be present in an amount from 0.01 to 20 wt. %, more preferably 0.1 to wt. 15%, more preferably from 0.1 to 10 wt. %, even more preferably from 0.1 to 6.0 wt. %, most preferably from 0.5 to 6.0 wt. %, based on the total weight of the perfume particles.

The perfume particles of the present invention preferably comprise a colourant. The colourant may be a dye or a pigment or a mixture thereof. The colourant has the purpose to impart colour to the composition, it is not intended to be a shading dye or to impart colour to the laundered fabrics. A single colourant or a mixture of colourants may be used.

Preferably, the colourant is a dye, more preferably a polymeric dye. Non-limiting examples of suitable dyes include the LIQUITINET range of dyes ex Milliken Chemical.

Preferably the perfume particles of the present invention comprise 0.001 to 2 wt. %, more preferably 0.005 to 1 wt. %, most preferably 0.01 to 0.6 wt. % colourant.

The perfume particles of the present invention may contain further optional laundry ingredients. Such ingredients include preservatives, pH buffering agents, perfume carriers, hydrotropes, polyelectrolytes, anti-shrinking agents, anti-oxidants, anti-corrosion agents, drape imparting agents, anti-static agents, ironing aids, anti-wrinkle agents, antifoams, pearlisers and/or opacifiers, natural oils/extracts, processing aids, e.g. electrolytes, anti-malodour agents, hygiene agents, e.g. anti-bacteria's, antifungals, anti-virals, low levels of cationic surfactants such as quaternary ammonium compounds and skin benefit agents.

The perfume particles may be in any particulate form, for example: powder, pellet, tablet, prill, pastille or extrudate. Preferably the perfume particles are in the form of a pastille or extrudate. Pastilles can, for example, be produced using ROTOFORMER Granulation Systems ex. Sandvick Materials.

The perfume particles of the present invention may be formed from a melt. The solid composition can for example, be formed into particles by: Pastillation e.g. using a ROTOFORMER ex Sandvick Materials, extrusion, prilling, by using moulds, casting the melt and cutting to size or spraying the melt.

An example manufacturing process may involve melting the carrier material at a temperature above the melting point of the carrier material, preferably at least 2° C. above the melting point of the carrier material, more preferably at least 5° C. above the melting point of the carrier material. Where more than one carrier materials are used, the melting point is considered to be the highest of the melting points of the individual materials. Once melted, the perfume and other ingredients may be mixed into the compositions. This is followed by a process in which the melt in cooled and shaped, e.g. extrusion or pastillation.

The perfume particles of the present invention are preferably homogeneously structured. By homogeneous, it is meant that there is a continuous phase throughout the solid product. There is not a core and shell type structure. Any particles present, such as perfume microcapsules will be distributed within the continuous phase. The continuous phase is provided predominately by the carrier materials.

The perfume particles may be any shape or size suitable for dissolution in the laundry process. Preferably, each individual particle of the solid composition has a mass of between 0.95 mg to 5 grams, more preferably 0.01 to 1 gram and most preferably 0.02 to 0.5 grams. Preferably each individual particle has a maximum linear dimension in any direction of 1-10 mm, more preferably 2-8 mm and most preferably a maximum linear dimension of 4-6 mm i.e. the maximum dimension in any direction is between the ranges disclosed herein. The shape of the particles may be selected for example from spherical, hemispherical, compressed hemispherical, lentil shaped, oblong, or planar shapes such as petals. A preferred shape for the particles is hemispherical, i.e. a dome shaped wherein the height of the dome is less than the radius of the base. When the particles are compressed hemispherical, it is preferred that diameter of the substantially flat base provides the maximum linear dimension and the height of the particle is 1-5 mm, more preferably 2-3 mm. The dimensions of the particles of the present invention can be measured using Calipers.

The perfume particles may be added to the laundry process in either the wash or the rinse phase of the laundry process.

In one aspect of the present invention is provided a method of storing perfume particles as described herein, in packaging as described herein.

In another aspect of the present invention is provided use of packaging as described herein to contain perfume particles as described herein.

TABLE 1
Example composition of perfume particles

Inclusion % by weight

| Ingredient | 3 | 4 |
|---|---|---|
| PEG 8000 ¹ | 70 | 91.09 |
| Starch ² | 20 | — |
| Blue dye ³ | — | 0.01 |
| Free perfume | 7 | 5 |
| Perfume microcapsules | — | 2 |

PEG 8000 ¹—Polyglycol 8000 ex Clariant
Starch ²—Tapioca C*Creamgel 7001 ex Cargill
Blue dye ³—Milliken Liquitint Blue HP

1. A packaged laundry product comprising packaging and perfume particles contained in said packaging,
wherein the packaging comprises:
a. a receptacle farmed from a material comprising cellulosic fibres; and
b. 1 to 5 wt. % of the packaging a perfume barrier;
wherein the perfume particles comprise:
i. carrier material; and
ii. 0.5 to 20 wt. % perfume components
wherein the perfume particles have a maximum liner dimension of 1 to 10 mm.

2. The packaged laundry product according to claim 1, wherein the receptacle is formed from cardboard, paper pulp, other cellulosic materials, or a combination thereof.

3. The packaged laundry product according to claim 1, wherein the perfume barrier is either coated on the material comprising cellulosic fibres or incorporated into the material comprising cellulosic fibres.

4. The packaged laundry product according to claim 1, wherein the receptacle is a cuboid or a cylinder.

5. The packaged laundry product according to claim 1, wherein the receptacle comprises a child impeding closure.

6. The packaged laundry product according to claim 1, wherein the perfume barrier layer is selected from: polyglycolic acid (PGA), polyolefin (e.g., polyethylene, polypropylene), polyvinylidene chloride, polyvinyl alcohol, polyvinyl acetate, nanoclay, graphene, graphene oxide, calcium carbonate, wax, varnish, aluminium foil, metal, metal oxides and mixtures thereof.

7. The packaged laundry product according to any preceding claim 1, wherein the perfume particles comprise at least 50 wt. % carrier material.

8. The packaged laundry product according to claim 1, wherein the carrier material is selected from: synthetic polymers, proteins, saccharides, polysaccharides, water-soluble or water dispersible fillers, vegetable soap, ethoxylated non-ionic surfactants and combinations thereof.

9. The packaged laundry product according to claim 1, wherein the perfume components comprise free perfume.

10. The packaged laundry product according to claim 1, wherein the perfume components comprise encapsulated perfume.

11. The packaged laundry product according to claim 10, wherein the perfume particles comprise 0.01 to 20 wt. % encapsulated perfume.

12. (canceled)

13. The packaged laundry product according to claim 1, wherein the perfume particles are in the form of a pastille or extrudate.

14. A method of storing perfume particles, wherein perfume particles comprising a carrier and perfume components are contained in packaging comprising a receptacle formed from a material comprising cellulosic fibres; and 1 to 5 wt. % of the packaging a perfume barrier layer; wherein the perfume particles have a maximum liner dimension of 1 to 10 mm.

15. The packaged laundry product according to claim 6 wherein the polyolefin is polyethylene or polypropylene and the nanoclay is montmorillonite or vermiculite platelet.
